(19) United States
(12) Patent Application Publication
(10) Pub. No.: US 2004/0195838 A1
(43) Pub. Date: Oct. 7, 2004

(54) Autonomous electrogravitational energy alternator

(76) Inventor: Alejandro Tomas, Barcelona (ES)

Correspondence Address: ALEJANDRO TOMAS, SARDENYA 100 BAJOS, BARCELONA, 08018, ES

(21) Appl. No.: 10/629,836

(22) Filed: Jul. 30, 2003

(30) Foreign Application Priority Data
Apr. 7, 2003 (ES) P200300921

(51) Int. Cl. H02P 9/04

(52) U.S. Cl. 290/1 R

(57) ABSTRACT

SUBJECT OF THE INVENTION: This descriptive report refers to an invention patent application. The invention is an autonomous electrogravitational energy alternator, whose purpose is to function as a totally autonomous alternator, without the need to be used or driven by other auxiliary means, such as petrol or diesel internal combustion engines, gas or coal-fired turbines, nuclear power plants, etc.

Being completely autonomous, the invention doesn't require any fossil fuels and it doesn't pollute or produce waste of any kind.

The invention for which the patent application is being made is an autonomous electrogravitational energy alternator, whose main characteristic lies in its totally autonomous functioning, without the need to be driven by other auxiliary means, such as (as an indication rather than in quantitative terms) internal combustion engines driven by petrol, diesel or producer gas, hydraulic turbines driven by steam produced from gas or coal, nuclear power plants, or any method that provides motive force, such as solar energy, etc.

There is a patent claim for the upper and lower electromagnetic coils, as well as the circular magnetic rings with variable polarity in the upper and lower chassis, with an upper axle-housing chassis, upper fixing, dynamotor, principal alternator and intermediate loose pinions, with upper and lower stabilisers, as well as lateral inertia stabilisers and induction field.

The alternator herein described does not produce any pollution.

### DESCRIPTION OF THE INVENTION

The autonomous electrogravitational energy alternator proposed by this invention is based on the combination of mechanical and electromotive forces from magnetic fields and the levitation of rotors in a horizontal position. This means that the rotors, being above the chassis itself, avoid any rubbing or angular movements; this provides homogeneous operation and gathers the maximum amount of mechanical force from the principal rotors, thereby obtaining electrical energy.

To be more specific, the autonomous electrogravitational energy alternator of this invention is based on a principal axle, with a fixing nut and a support bearing, and high and low lateral inertia stabilisers and induction fields.

The invention incorporates electromagnetic coils, as well as magnetic circular rings with variable polarity in the upper and lower chassis, with an axle-housing chassis and an upper fixing, principal alternator and dynamotor pinions, and loose intermediate pinions; this provides a loose-pinion axle chassis and a dynamotor with a dynamotor pinion and intermediate loose pinions.

The invention has a principal alternator with its corresponding axle, as well as some levitation base plates, which pertain to the aforementioned principal alternator, with variable-field magnetic rings within the alternator base plates and dynamotor, as well as intermediate axle-housing chassis plates and fixings for all the elements.

Finally, it should be mentioned that the invention is fitted with a low inertia rotor, a threaded closure ring from the principal axle to the chassis, a fixing nut, a bearing-hosing separator in the principal rotor and several bearings in the principal axle, two central axle pinions in the upper section, the axles of the upper and lower loose intermediate pinions, emergency lateral bearings and bearings for the needles for guiding the principal axle.

### DESCRIPTION OF THE DRAWINGS

To complement this description, and with the aim of helping towards a better understanding of the characteristics of the invention, attached with this report are some diagrams which illustrate the following:

FIG. 1.—This corresponds to a view of a lateral elevation of the invention (autonomous electrogravitational energy alternator).

### SET-UP OF THE INVENTION

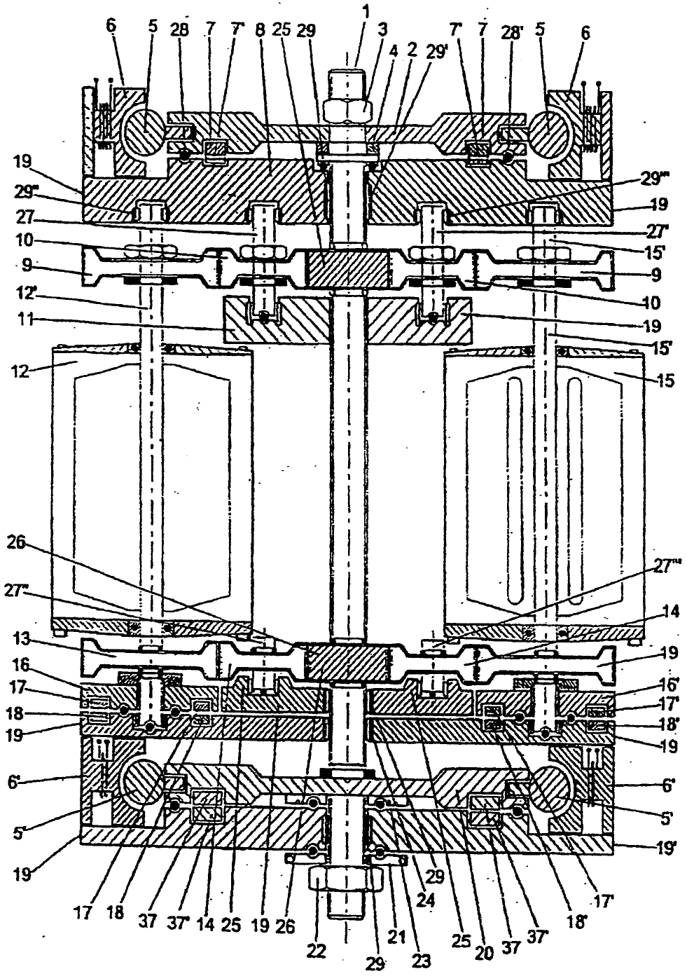

From FIG. 1 it is possible to see how the proposed autonomous electrogravitational energy alternator is made up around a dynamotor (12) which is responsible for bringing the whole unit into operation. This is outlined below:

The dynamotor (12) is fitted with two traction pinions (9) and (13) at its outlet which are responsible for moving the intermediate pinions (10) and (14), which in turn are responsible for moving the pinions (25) and (26) of the principal axle (1), bringing about movement in the high (2) and low (22) rotors.

When the principal axle (1) receives this movement from the dynamotor (12), it transmits movement to the pinions (10) and (14), which are configured as intermediate loose pinions located on the side of the alternator, engaging with the outlet pinions (9) and (19) the pinions of the principal alternator (15).

With the turning of the rotors (2) and (20) set to the rate of revolutions required by the coils (6) and (6′), the dynamotor switches off. The dynamotor (12) then changes function and begins to operate as an electric generator, together with the principal alternator (15), thus creating energy that is free to be used.

To prevent rubbing, in the principal rotors (2) and (20) there are electromagnets (7) and (7′) fitted in the upper section, configured as two pairs, with two more pairs (37) and (37′) in the lower section; these are responsible for levitating the whole central unit.

The spherical units (5) and (5′) located on the periphery of the rotors (2) and (20) are responsible for entering the magnetic fields produced by the coils (6) and (6′) in order to move the rotors (2) and (20), with these movements being in a pentagonal form of units with 90° angles and cosines of pi of 40°, creating a perfect turn and fully exploiting the inertia.

Both the dynamotor (12) and the alternator (15) have two fixing and inertia plates (16) for the installation of two electromagnets (17) and (17′), which work against the two electromagnets (18) and (18), which in turn are responsible for levitating the alternator (15) and the dynamotor (12).

As a consequence, both in the rotors (2) and (0) and the lower fixing plates (16) and (16′), the installation of the electromagnets (17) and (17′), as well as the electromagnets (18) and (18′), means that there are forces of repulsion present, which results in the levitation of the rotors (2) and (20), the dynamotor (12) and the alternator (15), all governed by the law of gravity.

In summary, the movement of the principal rotors (2) and (20), which are responsible for producing a sufficient level of inertia over the alternators (15) and the dynamotor (12), generates a movement that can be harnessed and transformed into electrical energy.

The invention allows for the possibility of adding elements to the machine or removing them, depending on the energy calculation that is carried out.

The following elements make up the machine:

Principal axle (1),

High inertia rotor (2),

Fixing nut (3),

Support bearing (4),

High lateral inertia stabilisers and induction fields (5),

Low lateral inertia stabilisers and induction fields (5′)

Upper electromagnetic coils (6),

Lower electromagnetic coils (6′),

Circular magnetic ring with variable polarity in the upper and lower chassis (7), (7′), (37) and (37′),

Axle-housing chassis and upper fixing (8),

Dynamotor and principal alternator pinions (9),

Intermediate loose pinions (10),

Loose pinion axle-housing chassis (11),

Dynamotor (12),

Dynamotor pinion (13),

Intermediate loose pinions (14),

Principal alternator (15),

Principal axle alternator (15′),

Levitation base plates (16) of the principal alternator (15),

Variable-field magnetic rings (17′) of the base plates (16) of the alternator (15) and dynamotor (12),

Magnetic rings (18) and (18′) of the base plates (16) and (16′) in the chassis of the alternator (15) and dynamotor (12),

Intermediate chassis plates (19) and (19′) between the axle-housing and the fixings of all elements,

Low inertia rotor (20),

Threaded closure ring (21) from the principal axle (1) to the chassis,

Fixing nut (22),

Separator (23) of the bearing housing of the low rotor,

Bearings (24) of the principal axle (1),

Central pinion (25) and (26) of the axle in the upper and lower parts respectively,

Axles (27) and (27′) of the upper and lower intermediate loose pinions,

Lateral bearings (28), (28′), (28″) and (28′″), as well as bearings (29) and needles for guiding the principal axle (1).

1. An autonomous electrogravitational energy alternator, which is distinguished by being made up of a principal axle (1), high inertia rotor (2), fixing nut (3), support bearing (4), high lateral inertia stabilisers and induction fields (5), low lateral inertia stabilisers and induction fields (5′), upper (6) and lower (6′) electromagnetic coils, circular magnetic rings with variable polarity (7) and (7′), axle-housing chassis and upper fixing (8), principal alternator and dynamotor pinions (9), loose intermediate pinions (10), loose-pinion axle-housing chassis (11), dynamotor (12), dynamotor pinion (13), intermediate loose pinions (14), principal alternator (15), principal axle alternator (15′), levitation base plates (16) of the principal alternator (1), magnetic rings (17), (17′), (18) and (18′), chassis plates (19) and (19′), low inertia rotor (20), threaded closure ring (21) from the principal axle (1) to the chassis, fixing nut (22), bearing-housing separator (23), bearings (24) of the principal axle (1), central pinion (25) and (26) of the axle in the upper and lower parts respectively, axles (27), (27′), (27″) and (27′″) of the upper and lower intermediate loose pinions, lateral emergency bearings (28) and (28′), and bearings (29) for the needles for guiding the principal axle (1).

2. Autonomous electrogravitational energy alternator, in accordance with the above features, distinguished by the dynamotor (12) being responsible for bringing the alternator into operation, having two traction pinions at its outlet (9) and (13), which are responsible for moving the intermediate pinions (10) and (14), which in turn are responsible for moving the pinions (25) and (26) of the principal axle (1), creating movement in the upper (2) and lower (22) rotors, so when the central axle receives the movement from the dynamotor (12) there is a movement transmission to the pinions (10) and (14) that are configured as loose intermediate pinions on the side of the alternator, engaging with the outlet pinions (9) and (19) of the principal alternator (15).

3. Autonomous electrogravitational energy alternator, in accordance with the above-mentioned features, distinguished by the turning of the rotors (2) and (20) at the revolution rate required by the coils (6) and (6′), causing the disconnection of the dynamotor (12), with the dynamotor (12) changing function and beginning to operate as an electric generator, together with the principal alternator (15).

4. Autonomous electrogravitational energy alternator, in accordance with the above-mentioned features, distinguished by the principal rotors (2) and (20) being designed for the fitting of electromagnets (7) and (7′) in the upper section, and the fitting of electromagnets (37) and (37′) in the lower section.

5. Autonomous electrogravitational energy alternator, in accordance with the above-mentioned features, distinguished by the spherical units (5) and (5′) located on the periphery of the rotors (2) and (20′); these spherical units enter the magnetic fields produced by the coils (6) and (6′) in order to move the rotors (2) and (20).

6. Autonomous electrogravitational energy alternator, in accordance with the above-mentioned features, distinguished by the dynamotor (12) and the alternator (15) being fitted with two fixing and inertia plates (16), on which electromagnets (17) and (17′) are fitted, working against the two electromagnets (18) and (18′).
